(19) United States
(12) Patent Application Publication
(10) Pub. No.: US 2026/0067174 A1
(43) Pub. Date: Mar. 5, 2026

(54) WIRELESS COMMUNICATION METHOD FOR DATA TRANSFER, DEVICE AND CHIP

(71) Applicant: INNOPEAK TECHNOLOGY, INC., Palo Alto, CA (US)

(72) Inventor: Tricci SO, Palo Alto, CA (US)

(21) Appl. No.: 19/104,518

(22) PCT Filed: Sep. 27, 2023
(86) PCT No.: PCT/US2023/033843

§ 371 Date: Feb. 18, 2025

Related U.S. Application Data
(60) Provisional application No. 63/410,607, filed on Sep. 27, 2022.
(60) Provisional application No. 63/411,548, filed on Sep. 29, 2022.

(51) Int. Cl. H04L 41/16; H04L 41/0894; H04W 28/02

(52) U.S. Cl. CPC H04L 41/16; H04L 41/0894; H04W 28/0236; H04W 28/0268

(57) ABSTRACT

A wireless communication method for data transfer includes receiving, by a function entity, a first request, wherein the first request indicates quality-of-service (QoS) parameters associated with a list of time windows for Application Artificial Intelligence (AI)/Machine Learning (ML) Data Transfer (AAMDT) and selecting, by the function entity, an AAMDT policy based on the QoS parameters.

### CROSS-REFERENCE TO RELATED APPLICATIONS

This application is a U.S. national stage of international application No. PCT/US2023/033843, filed on Sep. 27, 2023, which claims priorities to U.S. Provisional Application No. 63/410,607, filed on Sep. 27, 2022, and U.S. Provisional Application No. 63/411,548, filed on Sep. 29, 2022, all of which are incorporated by reference in their entireties.

### TECHNICAL FIELD

The present disclosure relates to the field of communication systems, and more particularly, to wireless communication method for data transfer and device and chip thereof, such as solutions for higher quality-of-service (QoS) assurance for planned and event driven application layer data transfer via support of multiple time windows and QoS performance data analytics extensions.

### BACKGROUND

There is currently standardization activity in 3rd generation partnership project (3GPP) work studying data transfer such as application artificial intelligence/machine learning (AI/ML) data transfer. However, in current technologies, enhancement for application AI/ML data transfer and related parameters is still an open issue.

Therefore, there is a need for communication method for data transfer such as solutions for higher quality-of-service (QoS) assurance for planned and event driven application layer data transfer via support of multiple time windows and QoS performance data analytics extensions.

### SUMMARY

An object of the present disclosure is to propose wireless communication method for data transfer such as solutions for higher quality-of-service (QoS) assurance for planned and event driven application layer data transfer via support of multiple time windows and QoS performance data analytics extensions.

In some embodiments of the present disclosure, a wireless communication method for data transfer includes receiving, by a function entity, a first request, wherein the first request indicates quality-of-service (QoS) parameters associated with a list of time windows for Application Artificial Intelligence (AI)/Machine Learning (ML) Data Transfer (AAMDT) and selecting, by the function entity, an AAMDT policy based on the QoS parameters.

In some embodiments of the present disclosure, a network device includes a memory, a transceiver, and a processor coupled to the memory and the transceiver. The network device is configured to: receive a first request, wherein the first request indicates QoS parameters associated with a list of time windows for AAMDT and select an AAMDT policy based on the QoS parameters.

In some embodiments of the present disclosure, a chip includes a processor, configured to call and run a computer program stored in a memory, to cause a device in which the chip is installed to: receive a first request, wherein the first request indicates QoS parameters associated with a list of time windows for AAMDT and select an AAMDT policy based on the QoS parameters.

### BRIEF DESCRIPTION OF DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1 is a block diagram of a function entity according to an embodiment of the present disclosure.

FIG. 2 is a flowchart illustrating a wireless communication method for data transfer by a function entity according to an embodiment of the present disclosure.

FIG. 3 is a block diagram of a function entity according to an embodiment of the present disclosure.

FIG. 4 is a flowchart illustrating a wireless communication method for data transfer by a function entity according to an embodiment of the present disclosure.

FIG. 5 is a block diagram of a communication device according to an embodiment of the present disclosure.

FIG. 6 is a block diagram of a communication device according to an embodiment of the present disclosure.

FIG. 7 is a block diagram of a network device according to an embodiment of the present disclosure.

FIG. 8 is a block diagram illustrating a wireless communication architecture configured to implement some embodiments presented herein.

FIG. 9 is a flowchart illustrating Application Artificial Intelligence (AI)/Machine Learning (ML) Data Transfer (AAMDT) policy negotiation for future protocol data unit (PDU) session to support an application layer data transfer configured to implement some embodiments presented herein.

FIG. 10 is a flowchart illustrating applying/updating/removing a negotiated AAMDT policy to a PDU session to support an application AI/ML data transfer configured to implement some embodiments presented herein.

FIG. 11 is a block diagram of an example of a computing device according to an embodiment of the present disclosure.

FIG. 12 is a block diagram of a communication system according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

Network capacity planning is a major challenge for any mobile operator. In order to enable Mobile Network Operators (MNOs) to assist Application Service Providers (ASPs) to transport their Application traffic (e.g. Application Artificial Intelligent & Machine Learning (AI/ML) traffic) in a more controlled time-table to ensure availability of network resources, the application AI/ML data transfer can be a non guaranteed bit rate (GBR) type or a GBR type that requires some resource reservations aimed to achieve a transmission performance requirement. For examples, for non GBR type, this can start a transmission for this model at midnight with the amount of resources that are available to complete the data transfer. For examples, for GBR type, Application Function (AF) may start the transmission for this model 10 minutes later and aims to complete the transmission in 1 second. This would mean that some 5G QoS identifier (5QI), GBR, packet delay budget (PDB), or packet loss rate (PLR) requirements are set for this type of traffic.

In order to enable the MNOs to assist ASPs to transport their application AI/ML traffic in a more controlled time-table under the considerations of the availability of network resources, some embodiments of the present disclosure propose to support pre-negotiation between an AF and a 5G system (5GS) to agree on a target time (one or more windows which can be selected from a list of time windows with expected quality-of-service (QoS) parameters. The list of time windows may be based on a prior Service Level Agreement (SLA) between the ASP and MNOs for traffic transmission to support a planned and event driven Application AI/ML traffic. 5G Core (5GC) of the 5GS may further refer to the 5GC Network Analytics vis the support from Network Date Analytics Function (NWDAF) and other assistance information to derive the list of the desired time windows with their respective QoS parameters for the data transfer.

Application Artificial Intelligence (AI)/Machine Learning (ML) Data Transfer (AAMDT) may support two data transfer policies, i.e., for a future PDU session and for an existing PDU session. With the considerations of the data transport requirements as described in the above some embodiments, even though an initial intent of AAMDT is to support non-time-critical data during off-hour, given the ability of AAMDT for being able to negotiate in advance for the desired data transfer time-table, data transfer policy (e.g. data volume, one or a group of UEs, network area information, etc.) for being able to re-negotiate one or more AAMDT policies to enable the AF to adapt to changing network conditions and to respond to event triggers. Some embodiments of the present disclosure can enhance current AAMDT mechanisms with extensions to provide higher QoS assurance to support the non-real-time Application data transfer that meets the operational behaviors as the following: in-time data transfer, event driven (e.g., responding to the threshold reporting of “Network Performance” from NWDAF for the area of interest and time window, UE's location etc.) data transfer, and dynamic policy adaptation data transfer, etc.

Some embodiments may refer to the extension of the AAMDT, and some embodiments may refer Application AI/ML Data Transfer (i.e., AAMDT). In some embodiments, an enhancement proposed by the solution is to extend a current AAMDT data transfer time window negotiation (i.e., Desired Time Window and desTimeInt, etc.) to support more than one AAMDT data transfer time window when they are requested by the AF during the AAMDT Transfer policy negotiation with the 5GC. The AF may subsequently select a specific negotiated AAMDT Transfer policy corresponding to a specific time window to proceed with the AAMDT data transfer.

Further, in some embodiments, key performance indicators (KPIs) can be defined for QoS performance for the data transfer to support Application AI/ML traffic, i.e., split AI/ML inference, AI/ML model download, and Federated Learning (FL) learning. In order to leverage the existing/current AAMDT mechanisms as described above to support the non-real-time Application traffic, the AAMDT Transfer Policy needs to be extended to support additional QoS parameters beyond the traffic volume per user equipment (UE) that has been defined. The following additional QoS parameters that are proposed by some embodiments of this invention to be added to the AAMDT Transfer Policy to support Application AI/ML traffic may include at least one of the followings:
1. Overall Average and Maximum Packet Delay Budget for UL/DL per UE per time window.
2. Overall Average and Maximum Packet Loss Rate for UL/DL per UE per time window.
3. Guaranteed and Maximum Traffic rate for UL/DL per UE per time window.
NOTE: The QoS parameters for uplink and downlink may be asymmetrical.

In some embodiments, Policy Control Function (PCF) may refer to “Network Performance” analytics from NWDAF to determine the candidate list of AAMDT policies. In order to assist PCF to obtain a better estimate of the QoS parameters for the AAMDT policy, some embodiments of this invention propose to enhance the “Network Performance” analytics with an added set of input parameters to enable the NWDAF to derive the performance statistic and predictions for the set of QoS parameters among UEs.

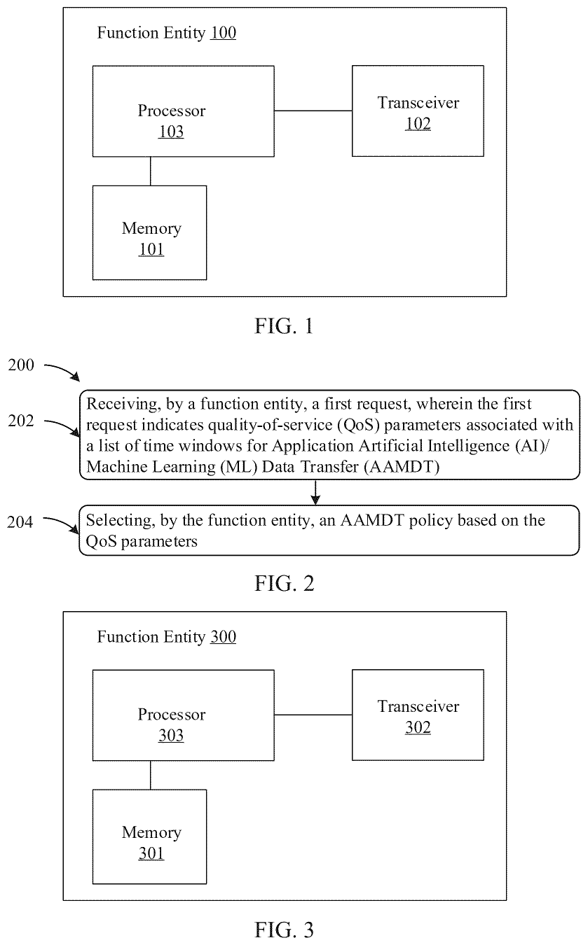

FIG. 1 illustrates an example of a function entity 100 according to an embodiment of the present disclosure. The function entity 100 is configured to implement some embodiments of the disclosure. Some embodiments of the disclosure may be implemented into the function entity 100 using any suitably configured hardware and/or software. The function entity 100 may include a memory 101, a transceiver 102, and aprocessor 103 coupled to the memory 101 and the transceiver 102. The processor 103 may be configured to implement proposed functions, procedures and/or methods described in this description. Layers of radio interface protocol may be implemented in the processor 103. The memory 101 is operatively coupled with the processor 103 and stores a variety of information to operate the processor 103. The transceiver 102 is operatively coupled with the processor 103, and the transceiver 102 transmits and/or receives a radio signal. The processor 103 may include application-specific integrated circuit (ASIC), other chipset, logic circuit and/or data processing device. The memory 101 may include read-only memory (ROM), random access memory (RAM), flash memory, memory card, storage medium and/or other storage device. The transceiver 102 may include baseband circuitry to process radio frequency signals. When the embodiments are implemented in software, the techniques described herein can be implemented with modules (e.g., procedures, functions, and so on) that perform the functions described herein. The modules can be stored in the memory 101 and executed by the processor 103. The memory 101 can be implemented within the processor 103 or external to the processor 103 in which case those can be communicatively coupled to the processor 103 via various means as is known in the art.

In some embodiments, the memory 101 stores executable instructions that when executed by the processor 103 cause the processor 103 to effectuate operations including: receiving a first request, wherein the first request indicates quality-of-service (QoS) parameters associated with a list of time windows for AAMDT and selecting an AAMDT policy based on the QoS parameters. This can solve these issues in the prior art and other issues and/or meet QoS requirements of an application AI/ML data transfer.

FIG. 2 illustrates a wireless communication method for data transfer by a function entity according to an embodiment of the present disclosure. FIG. 2 is an example of a communication method 200 for data transfer according to an embodiment of the present disclosure. The communication method 200 for data transfer is configured to implement some embodiments of the disclosure. Some embodiments of the disclosure may be implemented into the communication method 200 for data transfer using any suitably configured hardware and/or software. In some embodiments, the communication method 200 for data transfer includes: an operation 202, receiving, by a function entity, a first request, wherein the first request indicates quality-of-service (QoS) parameters associated with a list of time windows for AAMDT, and an operation 204, selecting, by the function entity, an AAMDT policy based on the QoS parameters. This can solve these issues in the prior art and other issues and/or meet QoS requirements of an application AI/ML data transfer.

In some embodiments, the function entity is a Policy Control Function (PCF) entity. In some embodiments, the first request is an AAMDT policy control request, and the first request is request from an Application Function (AF) via a Network Exposure Function (NEF) entity. In some embodiments, the method further includes requesting, by the function entity, network performance analytics associated with the QoS parameters. In some embodiments, the AAMDT policy is selected based on the network performance analytics. In some embodiments, the method further includes sending, by the function entity, the AAMDT transfer policy. In some embodiments, the AAMDT transfer policy is sent to the AF. Optionally, in some embodiments, the AAMDT transfer policy is sent to the AF via the NEF.

In some embodiments, the method further includes receiving, by the function entity, a second request to create or update the AAMDT policy. In some embodiments, the second request is an AF request, and the AAMDT policy is associated with the AAMDT for a protocol data unit (PDU) session served by the function entity. In some embodiments, the method further includes attempting, by the function entity, to authorize the second request. In some embodiments, the method further includes retrieving, by the function entity, an AAMDT policy from a User Data Repository (UDR) entity. In some embodiments, the method further includes deriving, by the function entity, a set of policy and charging control (PCC) rules for the AAMDT based on the AAMDT policy. In some embodiments, the method further includes initiating, by the function entity, a Session Management (SM) policy association modification with a Session Management Function (SMF) entity based on the set of PCC rules. In some embodiments, the QoS parameters include a guaranteed bit rate (GBR) and at least one of a packet delay budget (PDB), a packet loss rate (PLR), and a traffic rate.

FIG. 3 illustrates an example of a function entity 300 according to an embodiment of the present disclosure. The function entity 300 is configured to implement some embodiments of the disclosure. Some embodiments of the disclosure may be implemented into the function entity 300 using any suitably configured hardware and/or software. The function entity 300 may include a memory 301, a transceiver 302, and a processor 303 coupled to the memory 301 and the transceiver 302. The processor 303 may be configured to implement proposed functions, procedures and/or methods described in this description. Layers of radio interface protocol may be implemented in the processor 303. The memory 301 is operatively coupled with the processor 303 and stores a variety of information to operate the processor 303. The transceiver 302 is operatively coupled with the processor 303, and the transceiver 302 transmits and/or receives a radio signal. The processor 303 may include application-specific integrated circuit (ASIC), other chipset, logic circuit and/or data processing device. The memory 301 may include read-only memory (ROM), random access memory (RAM), flash memory, memory card, storage medium and/or other storage device. The transceiver 302 may include baseband circuitry to process radio frequency signals. When the embodiments are implemented in software, the techniques described herein can be implemented with modules (e.g., procedures, functions, and so on) that perform the functions described herein. The modules can be stored in the memory 301 and executed by the processor 303. The memory 301 can be implemented within the processor 303 or external to the processor 303 in which case those can be communicatively coupled to the processor 303 via various means as is known in the art.

In some embodiments, the memory 301 stores executable instructions that when executed by the processor 303 cause the processor 303 to effectuate operations including: receiving a first request to create or update an AAMDT policy based on quality-of-service (QoS) parameters associated with a list of time windows for AAMDT and deriving a set of policy and charging control (PCC) rules for the AAMDT based on an AAMDT policy. This can solve these issues in the prior art and other issues and/or meet QoS requirements of an application AI/ML data transfer.

FIG. 4 illustrates a communication method for data transfer by a function entity according to an embodiment of the present disclosure. FIG. 4 is an example of a communication method 400 for data transfer according to an embodiment of the present disclosure. The communication method 400 for data transfer is configured to implement some embodiments of the disclosure. Some embodiments of the disclosure may be implemented into the communication method 400 for data transfer using any suitably configured hardware and/or software. In some embodiments, the communication method 400 for data transfer includes: an operation 402, receiving, by a function entity, a first request to create or update an AAMDT policy based on quality-of-service (QoS) parameters associated with a list of time windows for AAMDT, and an operation 404, deriving, by the function entity, a set of policy and charging control (PCC) rules for the AAMDT based on an AAMDT policy. This can solve these issues in the prior art and other issues and/or meet QoS requirements of an application AI/ML data transfer.

In some embodiments, the function entity is a Policy Control Function (PCF) entity. In some embodiments, the first request is an Application Function (AF) request, and the AAMDT policy is associated with the AAMDT for a protocol data unit (PDU) session served by the function entity. In some embodiments, the method further includes attempting, by the function entity, to authorize the second request. In some embodiments, the method further includes retrieving, by the function entity, the AAMDT policy from a User Data Repository (UDR) entity. In some embodiments, the method further includes initiating, by the function entity, a Session Management (SM) policy association modification with a Session Management Function (SMF) entity based on the set of PCC rules.

In some embodiments, the method further includes receiving, by the function entity, a second request, wherein the second request indicates the QoS parameters. In some embodiments, the method further includes selecting, by the function entity, the AAMDT policy based on the QoS parameters. In some embodiments, the second request is an AAMDT policy control request, and the second request is request from an Application Function (AF) via a Network Exposure Function (NEF) entity. In some embodiments, the method further includes requesting, by the function entity, network performance analytics associated with the QoS parameters. In some embodiments, the AAMDT policy is selected based on the network performance analytics. In some embodiments, the method further includes sending, by the function entity, the AAMDT transfer policy. In some embodiments, the AAMDT transfer policy is sent to the AF. Optionally, in some embodiments, the AAMDT transfer policy is sent to the AF via the NEF. In some embodiments, the QoS parameters include a guaranteed bit rate (GBR) and at least one of a packet delay budget (PDB), a packet loss rate (PLR), and a traffic rate.

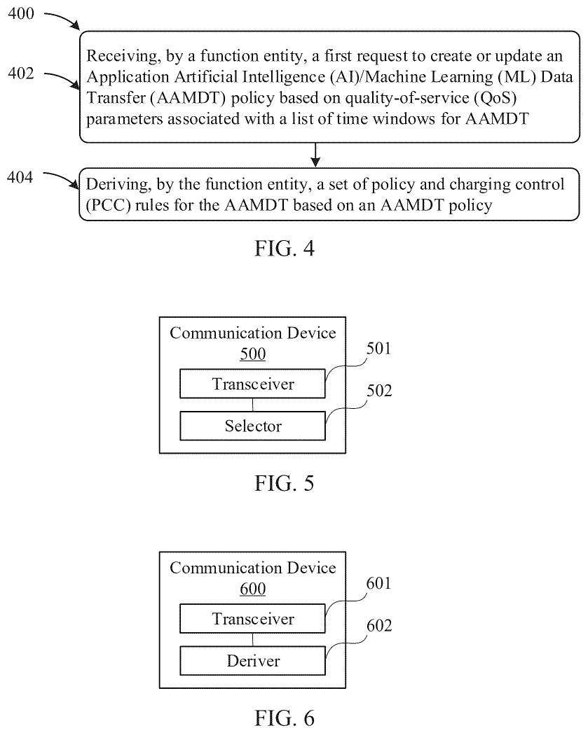

FIG. 5 illustrates a communication device according to an embodiment of the present disclosure. FIG. 5 illustrates that, in some embodiments, a communication device 500 includes a transceiver 501 configured to receive a first request, wherein the first request indicates quality-of-service (QoS) parameters associated with a list of time windows for AAMDT and a selector 502 configured to select an AAMDT policy based on the QoS parameters. This can solve these issues in the prior art and other issues and/or meet QoS requirements of an application AI/ML data transfer.

In some embodiments, the wireless communication device 500 is a Policy Control Function (PCF) entity. In some embodiments, the first request is an AAMDT policy control request, and the first request is request from an Application Function (AF) via a Network Exposure Function (NEF) entity. In some embodiments, the selector 502 is further configured to request network performance analytics associated with the QoS parameters. In some embodiments, the AAMDT policy is selected based on the network performance analytics. In some embodiments, the transceiver 501 is further configured to send the AAMDT transfer policy. In some embodiments, the AAMDT transfer policy is sent to the AF. Optionally, in some embodiments, the AAMDT transfer policy is sent to the AF via the NEF. In some embodiments, the transceiver 501 is further configured to receive a second request to create or update the AAMDT policy.

In some embodiments, the second request is an AF request, and the AAMDT policy is associated with the AAMDT for a protocol data unit (PDU) session served by the wireless communication device 500. In some embodiments, the selector 502 is further configured to attempt to authorize the second request. In some embodiments, the selector 502 is further configured to retrieve an AAMDT policy from a User Data Repository (UDR) entity. In some embodiments, the selector 502 is further configured to derive a set of policy and charging control (PCC) rules for the AAMDT based on the AAMDT policy. In some embodiments, the selector 502 is further configured to initiate a Session Management (SM) policy association modification with a Session Management Function (SMF) entity based on the set of PCC rules. In some embodiments, the QoS parameters include a guaranteed bit rate (GBR) and at least one of a packet delay budget (PDB), a packet loss rate (PLR), and a traffic rate.

FIG. 6 illustrates a communication device according to an embodiment of the present disclosure. FIG. 6 illustrates that, in some embodiments, a communication device 600 includes a transceiver 601 configured to receive a first request to create or update an Application Artificial Intelligence (AI)/Machine Learning (ML) Data Transfer (AAMDT) policy based on quality-of-service (QoS) parameters associated with a list of time windows for AAMDT and a deriver 602 configured to derive a set of policy and charging control (PCC) rules for the AAMDT based on an AAMDT policy. This can solve these issues in the prior art and other issues and/or meet QoS requirements of an application AI/ML data transfer.

In some embodiments, the wireless communication device 600 is a Policy Control Function (PCF) entity. In some embodiments, the first request is an Application Function (AF) request, and the AAMDT policy is associated with the AAMDT for a protocol data unit (PDU) session served by the wireless communication device 600. In some embodiments, the deriver 602 is further configured to attempt to authorize the second request. In some embodiments, the deriver 602 is further configured to retrieve the AAMDT policy from a User Data Repository (UDR) entity. In some embodiments, the deriver 602 is further configured to initiate a Session Management (SM) policy association modification with a Session Management Function (SMF) entity based on the set of PCC rules. In some embodiments, the transceiver 601 is further configured to receive a second request, and the second request indicates the QoS parameters. In some embodiments, the deriver 602 is further configured to select the AAMDT policy based on the QoS parameters.

In some embodiments, the second request is an AAMDT policy control request, and the second request is request from an Application Function (AF) via a Network Exposure Function (NEF) entity. In some embodiments, the deriver 602 is further configured to request network performance analytics associated with the QoS parameters. In some embodiments, the AAMDT policy is selected based on the network performance analytics. In some embodiments, the transceiver 601 is further configured to send the AAMDT transfer policy. In some embodiments, the AAMDT transfer policy is sent to the AF. Optionally, in some embodiments, the AAMDT transfer policy is sent to the AF via the NEF. In some embodiments, the QoS parameters include a guaranteed bit rate (GBR) and at least one of a packet delay budget (PDB), a packet loss rate (PLR), and a traffic rate.

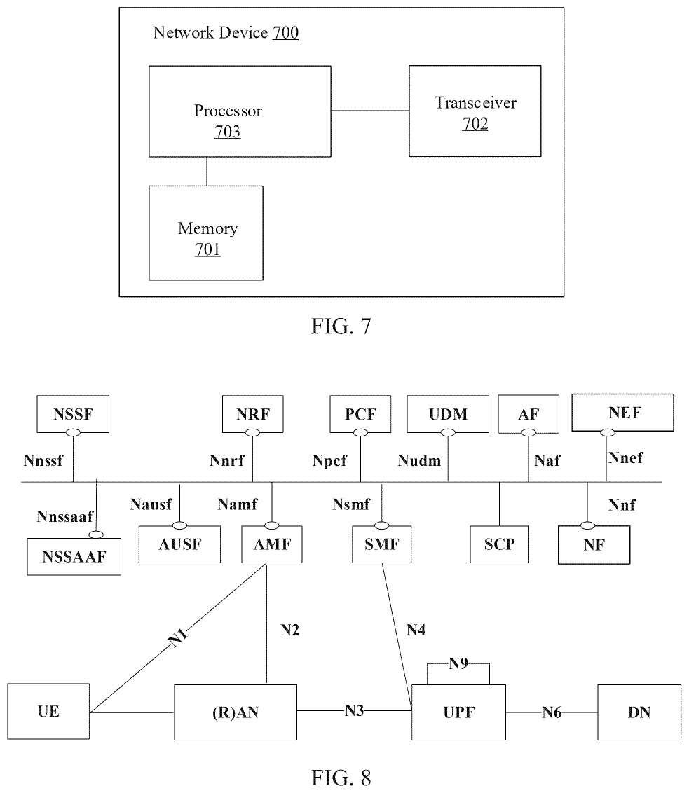

FIG. 7 illustrates an example of a network device 700 according to an embodiment of the present disclosure. The network device 700 is configured to implement some embodiments of the disclosure. Some embodiments of the disclosure may be implemented into the network device 700 using any suitably configured hardware and/or software. The network device 700 may include a memory 701, a transceiver 702, and a processor 703 coupled to the memory 701 and the transceiver 702. The processor 703 may be configured to implement proposed functions, procedures and/or methods described in this description. Layers of radio interface protocol may be implemented in the processor 703. The memory 701 is operatively coupled with the processor 703 and stores a variety of information to operate the processor 703. The transceiver 702 is operatively coupled with the processor 703, and the transceiver 702 transmits and/or receives a radio signal. The processor 703 may include application-specific integrated circuit (ASIC), other chipset, logic circuit and/or data processing device. The memory 701 may include read-only memory (ROM), random access memory (RAM), flash memory, memory card, storage medium and/or other storage device. The transceiver 702 may include baseband circuitry to process radio frequency signals. When the embodiments are implemented in software, the techniques described herein can be implemented with modules (e.g., procedures, functions, and so on) that perform the functions described herein. The modules can be stored in the memory 701 and executed by the processor 703. The memory 701 can be implemented within the processor 703 or external to the processor 703 in which case those can be communicatively coupled to the processor 703 via various means as is known in the art.

In some embodiments, the memory 701 stores executable instructions that when executed by the processor 703 cause the processor 703 to effectuate operations including: receiving a first request, wherein the first request indicates quality-of-service (QoS) parameters associated with a list of time windows for Application Artificial Intelligence (AI)/Machine Learning (ML) Data Transfer (AAMDT) and selecting an Application Artificial Intelligence (AI)/Machine Learning (ML) Data Transfer (AAMDT) policy based on the QoS parameters. In some embodiments, the memory 701 stores executable instructions that when executed by the processor 703 cause the processor 703 to effectuate operations including: receiving a first request to create or update an Application Artificial Intelligence (AI)/Machine Learning (ML) Data Transfer (AAMDT) policy based on quality-of-service (QoS) parameters associated with a list of time windows for Application Artificial Intelligence (AI)/Machine Learning (ML) Data Transfer (AAMDT) and deriving a set of policy and charging control (PCC) rules for the AAMDT based on an AAMDT policy. The network device 700 is configured to perform the above method in some embodiments. This can solve these issues in the prior art and other issues and/or meet QoS requirements of an application AI/ML data transfer.

FIG. 8 illustrates a wireless communication architecture configured to implement some embodiments presented herein. FIG. 8 illustrates that in some embodiments, in the wireless communication architecture, network functions communicate with each other over a service-based interface in a core network (CN). A user equipment (UE) may communicate with the core network to establish control signaling and enable the UE to use services from the CN. Examples of control signaling functions are registration, connection and mobility management, authentication and authorization, session management, etc. After control signaling have been established, the UE can then utilize the user plane functionality to send and receive data to and from a data network (DN), e.g., the internet.

In some examples, the wireless communication architecture may include the following network functions (NF): authentication server function (AUSF), access and mobility management function (AMF), data network (DN), e.g., operator services, Internet access or 3rd party services, network exposure function (NEF), network repository function (NRF), network slice-specific and SNPN authentication and authorization function (NSSAAF), network slice selection function (NSSF), policy control function (PCF), session management function (SMF), unified data management (UDM), user plane function (UPF), application function (AF), user equipment (UE), (radio) access network ((R)AN), etc.

The following descriptions highlight some of the capabilities of the network functions (NFs) from FIG. 8 that are involved with control signaling.

Access and mobility function (AMF): The UE sends an N1 message through the RAN node to the AMF to perform control plane signaling such as registration, connection management, mobility management, access authentication and authorization, etc.

Session management function (SMF): The SMF is responsible for session management involved with establishing PDU sessions to allow UEs to send data to Data Networks (DNs) such as the internet or to an application server and other session management related functions.

Policy and control function (PCF): The PCF provides the policy framework that governs network behavior, accesses subscription information to make policy decisions, etc.

Authentication server function (AUSF): The AUSF supports authentication of UEs for 3GPP and untrusted non-3GPP accesses.

Unified data management/repository (UDM/UDR): The UDM/UDR supports generation of 3GPP AKA Authentication Credentials, user identification handling, subscription management and storage, etc.

Network slice selection function (NSSF): The NSSF is involved with aspects of network slice management such as selection of network slice instances for UEs, management of NSSAIs, etc.

Network repository function (NRF): The NRF supports service discovery function in the 5G network.

Network exposure function (NEF): The NEF supports the exposure of capabilities and events in the core network to third parties, application functions (AFs), edge computing, etc.

The RAN node offers communication access from the UE to the core network for both control plane and user plane communications. A UE establishes a PDU session with the CN to send data traffic over the user plane through the (R)AN and UPF nodes of the 5G system (5GS). Uplink traffic is sent by the UE and downlink traffic is received by the UE using the established PDU session. Data traffic flows between the UE and the DN through the intermediary nodes: (R)AN and UPF.

### Examples:

The intent of some embodiments of this invention is to extend the existing AAMDT data transfer mechanism to support planned and event driven Application AI/ML data transfer. Some embodiments of this invention may describe the extensions to the AAMDT transfer policy. The extensions include the ability to negotiate a list of time windows between the AF and the 5GC instead of just one time window that is currently defined. The extensions include also to enhance the support for additional QoS parameters instead of just the aggregated bit rate, specifically, such as the average and maximum Packet Delay for UL/DL, average and maximum Packet Loss Rate for UL/DL and guaranteed and maximum Traffic Rate for UL/DL.

Some embodiments of this invention also propose to enhance the Network Performance analytics by NWDAF to support the additional QoS performance analytics for at lesat one of new QoS parameters (i.e. PDB, PLR, and traffic rate, etc.) as described below. PCF may subscribe to such analytics to assist its decision to derive the AAMDT Transfer policy for the selected time window(s).
1. Overall Average and Maximum Packet Delay Budget for UL/DL per UE per time window.
2. Overall Average and Maximum Packet Loss Rate for UL/DL per UE per time window.
3. Overall Average, Minimum and Maximum Traffic rate for UL/DL per UE per time window.

Some embodiments of this invention also update the existing AAMDT negotiation procedures to support the ability of the AF to request a list of AAMDT time windows and the additional QoS parameters. In addition, it clarifies the existing procedure on how AIML AF discovers its serving NEF as well as the need for the NEF to authenticate/authorize the AIML AF. Finally, this solution clarifies the procedures on how AAMDT can be applied to the existing or future PDU session.

In some examples, one or more negotiated AAMDT policies could be provided by PCF to AF via NEF. The AF may select one of them and inform the PCF about the selected AAMDT Transfer policy together with the AAMDT Transfer Reference ID. Prior to the desired time window started for the Application AI/ML data transfer, the AF may initiate the AF request towards PCF to apply the selected AAMDT Transfer policy to the selected target UEs' PDU sessions. The PCF may determine the appropriate PCC rules according to the negotiated AAMDT Transfer policy for each of these PDU sessions.

### Examples: Extensions for AAMDT Mechanism to Support Application Layer Data Transfer

In some examples, in order to enable the AF to indicate a list of Desired time windows for AAMDT, the input parameter for the Nnef_AAMDT PNegotiation_Create is extended to support the list of Desired time windows and additional QoS parameters (e.g. PDB, PLR etc.) for the specific Application AI/ML data transfer requested by the AF. The current AAMDT data transfer policy does not support the individual QoS parameters other than the maximum aggregated bitrate. Some embodiments of this invention proposes to enhance the AAMDT transfer policy to be used as AAMDT Transfer policy with at lesat one of following additional QoS parameters:
1. Average and Maximum Packet Delay for UL/DL per UE per Time Windown.
2. Average and Maximum Packet Loss Rate for UL/DL per UE per Time Windown.
3. Guaranteed and Maximum Traffic rate for UL/DL per UE per Time Window.

In some examples, during the AAMDT Transfer policy negotiation and before activation procedures, the PCF may subscribe to NWDAF for the Network Performance Analytics to collect the performance statistic and to derive the performance prediction on those QoS parameters. Based on the analytics report, the PCF may propose to re-negotiate the AAMDT Transfer policy prior to the activation of the corresponding AAMDT time window.

In some examples, in order to enhance the Network Performance analytics to report the prediction of the QoS performance, this solution proposes to add the following input parameters to the Network Performance Analytics together with the UE's performance data collected from the AF as shown in Table 1 below to enable the NWDAF to derive the extended Network Performance analytics for the set of the QoS performance statistic and predictions corresponding to the specified time window: i.e., the identification of the target application(s) for the analytics information, i.e. Application ID(s), and the corresponding IP address/FQDN.

TABLE 1
Performance Data from AF

| Information | Source | Description |
|---|---|---|
| UE identifier | AF | IP address of the UE at the time the measurements |
| | | was made. |
| UE location | AF | The location of the UE when the performance |
| | | measurement was made. |
| Application ID | AF | To identify the service and support analytics per |
| | | type of service (the desired level of service). |
| IP filter information | AF | Identify a service flow of the UE for the application. |
| Locations of Application | AF/NEF | Locations of application represented by a list of |
| | | DNAI(s). The NEF may map the AF-Service- |
| | | Identifier information to a list of DNAI(s) when the |
| | | DNAI(s) being used by the application are statically |
| | | defined. |
| Application Server Instance address | AF/NEF | The IP address/FQDN of the Application Server that |
| | | the UE had a communication session when the |
| | | measurement was made. |
| Performance Data | AF | The performance associated with the communication |
| | | session of the UE with an Application Server that |
| | | includes: Average/Maximum Packet Delay, |
| | | Average/Maximum Loss Rate and |
| | | Average/Minimum/Maximum Throughput, etc. |
| Timestamp | AF | A time stamp associated to the Performance Data |
| | | provided by the AF. |

Based on the input parameters above, in some examples, the NWDAF may subscribe to the “Performance Data from AF” either directly for trusted AFs by invoking Naf_EventExposure_Subscribe service (Event ID=Performance Data, Event Filter information=Area of Interest, Application ID), or indirectly for untrusted AFs via NEF by invoking Nnef_EventExposure_Subscribe service (Event ID=Performance Data, Event Filter information=Area of Interest, Application ID) where NEF translates the Area of Interest into geographic zone identifier(s) in order to derive the performance statistic and prediction indicators for the following new QoS parameters corresponding to the examplary specific Desired time window:
1. Maximum/Average Packet Delay for UL/DL per UE per Time Window.
2. Maximum/Average Packet Loss Rate for UL/DL per UE per Time Window.
3. Maximum/Minimum/Average Traffic Rate for UL/DL per UE per Time Window.

In some examples, the PCF may then refer to such performance analytics information to derive the PCC rules for the UEs who participate in the AAMDT operation.

### Examples: AAMDT Negotiation for Future PDU Session to Support Application Layer Data Transfer

Some examples present further clarifications on how to leverage the existing AAMDT procedures for negotiation for future background data transfer to support the Application data transfer. Prior to the PDU session is established to support the AAMDT within the specified time-window, AF initiates requests to its serving NEF to (re)negotiate AAMDT policy that would have been pre-provisioned in UDR.

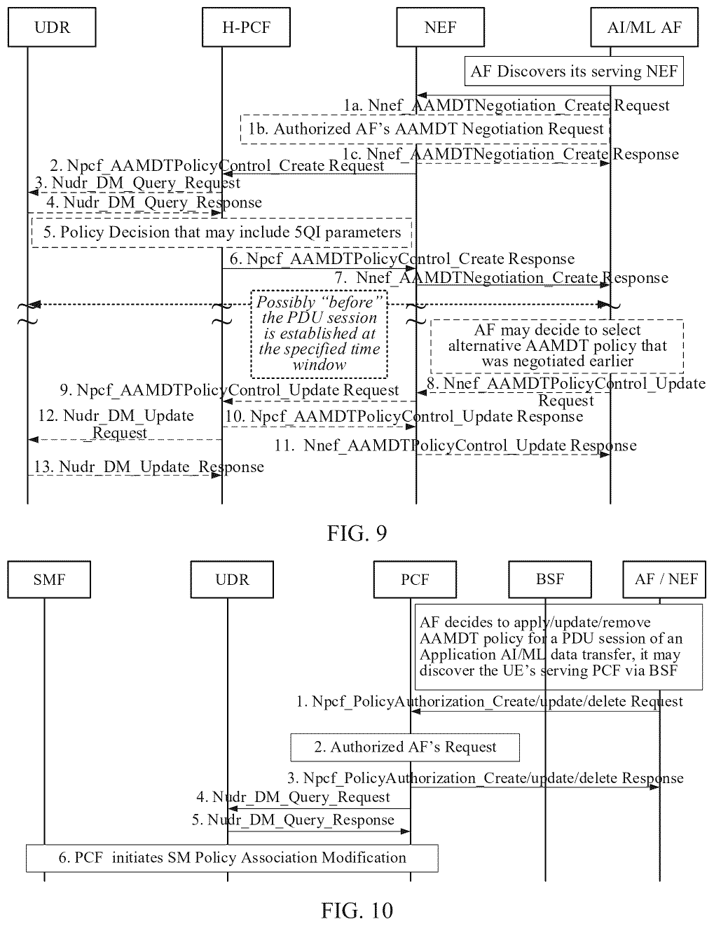

FIG. 9 illustrates Application Artificial Intelligence (AI)/Machine Learning (ML) Data Transfer (AAMDT) policy negotiation for future protocol data unit (PDU) session to support an application layer data transfer configured to implement some embodiments presented herein. The procedures as illustrated in FIG. 9 may support negotiation for future background data transfer and/or the AAMDT mechanism as proposed by some embodiments of this invention. The following descriptions focus on the changes to the current procedures:

Prior to the transport of the Application AI/ML data within the specified time-window, the AF negotiates with the 5G Core for the AAMDT Transfer policies that apply to its given Application AI/ML data transfer corresponding to the authorized 3rd party (i.e. AF), the AF is required to discover its serving NEF, if it has not done so, using the pre-defined mechanism as 3GPP Specification.

The procedures as illustrated in FIG. 9 may include at least one of following operations. These operations can be performed in parallel or sequentially.

In step 1a, the list of parameters for Nnef_AAMDTNegotiation_Create Request from AF may include the list of Desired time windows, the AI/ML AF may include also the latency and reliability requirements for the specific Application AI/ML operation as above some embodiments.

In step 1b, the NEF may authenticate the AF and authorize the AAMDT request from the AF. If the given AF is not authenticated and authorized, the NEF may reject AF's request through the Nnef_AAMDTNegotiation_Create Response, and the following steps are skipped.

In step 2, the list of parameters for Npcf AAMDTPolicyControl_Create Request from AF may include the list of Desired time windows, the NEF includes the added latency and reliability requirements for the specific Application AI/ML operation if they have been received from the AF.

In step 4, PDB and PLR etc. QoS parameters may also be provided by UDR as part of the AAMDT policies to the PCF. This may happen if the PCF (or another PCF) had received from the AF/NEF in a previous AAMDT negotiation regarding the latency and reliability requirements which are described in the form of PDB and PLR etc. QoS parameters, and are stored in the UDR.

In Steps 5, 6, the PCF refers to the requested QoS requirements specified by the AF. As described in current step 5, the PCF may subscribe to the NWDAF to request the Network Performance analytics for the set of QoS parameters' performance for each Desired time window from the list and the Network Area Information. The PCF may determine the PDB, PLR, etc. QoS parameters based on the QoS requirements from the AF for the corresponding Desired time window(s) which may be based on the reports of the Network Performance analytics to be included in the set of AAMDT Transfer policies. The PCF may also invalidate some of the old AAMDT Transfer policies. The PCF sends the final set of AAMDT Transfer policies to the AF via NEF together with the AAMDT Transfer Reference ID.

After the AAMDT Transfer policy negotiation, if the AF decides to select an alternative AAMDT Transfer policy (e.g. data rate reduction, relaxing delay constraints of planned and event driven traffic etc.), the AF may trigger step 8 to update the corresponding PCF via the support of NEF for the new selected AAMDT Transfer policy.

In step 12, the additional QoS parameters may be added to the UDR by the PCF as part of the updated AAMDT policies.

### Examples: Activation or Updating/Removing AAMDT (i.e. AAMDT) Transfer Policy to a PDU Session

Some examples may describe two ways to apply the negotiated AAMDT Transfer policy for a given Application AI/ML data transfer to the PDU Session(s) for given UE(s), i.e., (a) activating the AAMDT (i.e., AAMDT) Transfer policy as described in clause 4.2 above to a PDU session; and (b) adding PDU session of the target UE to the Desired AAMDT time window by applying the AAMDT Transfer policy.

In some examples, for the activation of the previously negotiated AAMDT Transfer policy to a PDU session to support the Application AI/ML data transfer, before the start of the AAMDT transfer Desired time window, the AF triggers Npcf_PolicyAuthorization_Create/Update via NEF or directly to PCF. The AF may discover the PCF (may be via NEF) via BSF by invoking Nbsf_Management_Discovery. In both cases, the PCF may leverage the negotiated AAMDT Transfer policy to generate the PCC rules to support the establishment of the future PDU session(s). For further details on how to apply the previously negotiated AAMDT Transfer policy can be referred to a pre-defined way in 3GPP specification.

In some examples, if the PDU session has been established and the AF would like to apply/update/delete the AAMDT Transfer policy to such existing PDU session for individual UE to support the Application AI/ML data transfer, then the AF invokes the Npcf_PolicyAuthorization_Create/Update service directly to PCF (via the N5 interface). The AF may discover the PCF via BSF by invoking Nbsf_Management_Discovery. The AF also provides the AAMDT Reference ID together with the AF session information to the PCF that serves the PDU session. The PCF authorizes the AF request. If the PCF determines that the AF can't be authorized, it rejects the AF request. Once the PCF authorizes the AF request and if the AF request is to apply or to update the PDU session with the AAMDT Transfer policy, the PCF retrieves the corresponding AAMDT Transfer policy from UDR to derives the PCC rule for the AAMDT according to the transfer policy. In addition, the AF may specify the individual QoS parameters different than the AAMDT Transfer policy. The PCF then updates the SMF with corresponding new PCC rule(s) with PCF initiated SM Policy Association Modification procedures can be pre-defined in 3GPP specification. Further details on how AF applies the AAMDT Transfer Policy to an existing session can be pre-defined in 3GPP specification.

In some examples, if the AF would like to remove the AAMDT Transfer policy for a PDU session of a given UE, AF invokes the Npcf_PolicyAuthorization_Delete service directly to PCF. The AF also provides the AAMDT Reference ID together with the AF session information to the PCF that serves the PDU session. The PCF authorizes the AF request as described above before removing the PDU session from the AAMDT.

FIG. 10 illustrates applying/updating/removing a negotiated AAMDT policy to a PDU session to support an application AI/ML data transfer configured to implement some embodiments presented herein. The procedures as illustrated in FIG. 10 may include at least one of following operations. These operations can be performed in parallel or sequentially.

Step 1. AF decides to apply/update/delete the AAMDT policy of a given application AI/ML data transfer for a PDU session, then the AF will, at the time the data transfer is about to start, provide, for the target UE, the AAMDT Reference ID together with the AF session information to the PCF that serves the PDU session (via the N5 interface). Note that AF may need to discover the UE's serving PCF via NEF with the support of BSF. This Npcf_PolicyAuthorization_Create/Update/Delete service can be pre-defined in 3GPP specification and is to authorise an AF request and to create policies as requested by the authorized AF for the PDU Session to which the AF session is bound. More specifically, the added latency and reliability requirements can be pre-defined in 3GPP specification and are included in the AI/ML AF request.

Step 2. The PCF authorizes the AF request.

Step 3. If the PCF determines that the AF can't be authorized, it rejects the AF request by including the rejection in Npcf_PolicyAuthorization_Create/Update/Delete response. All the subsequent steps below are skipped.

Steps 4-5. Once the PCF authorizes the AF request, if the AF request is to create or to update the AAMDT policy for the given PDU session, the PCF retrieves the corresponding AAMDT policy from UDR to derives the PCC rule(s) for the AAMDT according to the transfer policy that has been pre-provisioned which may include the Flock QoS policy consideration with the minimum QoS requirements. In addition, the AF may specify an alternative QoS policy to replace the AAMDT policy for the given PDU session.

Step 6. The PCF updates the SMF with corresponding new PCC rule(s) with PCF initiated SM Policy Association Modification procedures pre-defined in 3GPP specification.

Further details on how PCC rules are applied to either future or an existing PDU session can be pre-defined in 3GPP specification.

### Examples: QoS Sustainability & User Data Congestion Analytics Support for AAMDT Warning Notification

In some examples, in order to ensure that sufficient network resources are available to support the AAMDT when transfer window is approaching, this solution proposes to extend the Procedure for AAMDT warning notification as pre-defined in 3GPP specification to be extended to leverage the QoS Sustainability Analytic as pre-defined in 3GPP specification to assess the likelihood of a QoS change for an Analytics target period in the future in a certain area. The proposed update to a pre-defined 3GPP specification may be shown in “bold italic” below.

Proposed changes/undate to a pre-defined 3GPP specification:
1. The negotiation for Application Artificial Intelligence (AI)/Machine Learning (ML) Data Transfer
(AAMDT) described in a pre-defined 3GPP specification is completed. In addition, dependent on the PCF's
logic and local policy, the PCF has subscribed to any of the NWDAF analytics, such as the “Network
Performance”, etc. from NWDAF for the area of interest and the list of time windows of a background data
transfer policy following the procedure and services described in a pre-defined 3GPP specification, including
a Reporting Threshold in the Analytics Reporting information. The value for Reporting Threshold is set by
the PCF based on operator configuration.
2. The PCF is notified with the network performance, analytics in the area of interest from the NWDAF
when the NWDAF determines that the network performance goes below the threshold as described for the
subscribed NWDAF analytics such as the Network Performance, etc. analytics in a pre-defined 3GPP
specification.

In summary, in order to enable the MNOs to assist ASPs to transport their Application AI/ML traffic in a more controlled time-table under the considerations of the availability of network resources, some embodiments of this invention propose to extend the existing Application Artificial Intelligence (AI)/Machine Learning (ML) Data Transfer (AAMDT) mechanism to support pre-negotiation between the AF and the 5G system (5GS) to agree on the target time windows which is selected from a list of time windows with the expected QoS performance that meets the QoS requirements of the specified Application AI/ML data transfer. The current AAMDT mechanism supports only a single Desired time window negotiation. Furthermore, the current AAMDT mechanism supports only aggregated bit rate and not other QoS parameters (i.e. Packet Delay Budget, Packet Loss Rate and Packet Traffic Rate). Some embodiments of this invention propose the new mechanism referred as AAMDT to support a list of time windows negotiation between the AF and the 5GC of which the list of Desired time windows may be based on the prior Service Level Agreement (SLA) between the ASP and MNOs for the traffic transmission to support the planned and event driven Application AI/ML traffic. In addition, in some embodiments, each of these requested Desired time windows could be associated more than just the aggregated bit rate, instead, they are associated with the specific QoS parameters (i.e. Packet Delay Budget, Packet Loss Rate and Packet Traffic Rate) requested by the AF. Furthermore, in order to enable higher assurance for the 5G system to be able to grant the Desired time window for the AF's request for the Application AI/ML data transfer with the required QoS parameters, some embodiments of this invention propose to extend the existing Network Performance Analytics from NWDAF to support the QoS performance analytics on the additional QoS parameters (i.e. Packet Delay Budget, Packet Loss Rate and Packet Traffic Rate) in order to derive the list of the desired time windows with their respective QoS performance. Such analytics reports could be useful to assist the PCF to derive the appropriate PCC rules for the corresponding PDU sessions requested by the AF to support the specific Application AI/ML data transfer.

Commercial interests for some embodiments are as follows. 1. Solve issues in the prior art and other issues. 2. Meet QoS requirements of an application AI/ML data transfer. Some embodiments of the present disclosure can be used in many applications. Some embodiments of the present disclosure are used by chipset vendors, video system development vendors, automakers including cars, trains, trucks, buses, bicycles, moto-bikes, helmets, and etc., drones (unmanned aerial vehicles), smartphone makers, communication devices for public safety use, AR/VR/MR device maker for example gaming, conference/seminar, education purposes. Some embodiments of the present disclosure are a combination of “techniques/processes” that can be adopted in video standards to create an end product. Some embodiments of the present disclosure propose technical mechanisms. The at least one proposed solution, method, system, and apparatus of some embodiments of the present disclosure may be used for current and/or new/future standards regarding communication systems such as a UE, a base station, a network device, and/or a communication system. Compatible products follow at least one proposed solution, method, system, and apparatus of some embodiments of the present disclosure. The proposed solution, method, system, and apparatus are widely used in a UE, a base station, a network device, and/or a communication system. With the implementation of the at least one proposed solution, method, system, and apparatus of some embodiments of the present disclosure, at least one modification/improvement to methods and apparatus for data transfer are considered for standardizing.

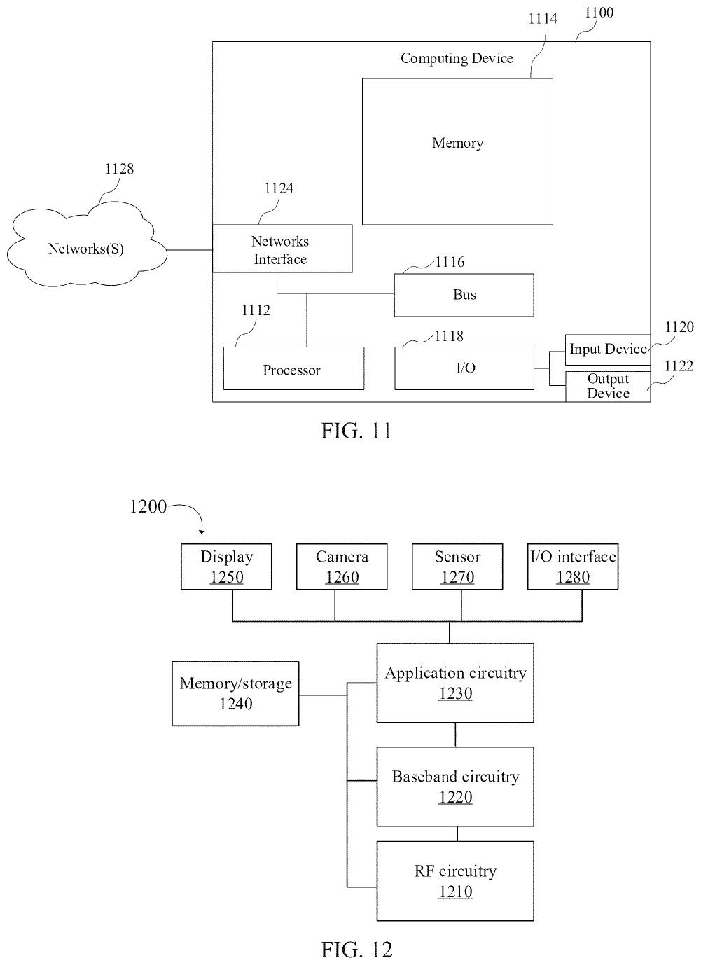

FIG. 11 is an example of a computing device 1100 according to an embodiment of the present disclosure. Any suitable computing device can be used for performing the operations described herein. For example, FIG. 11 illustrates an example of the computing device 1100 that can implement apparatuses and/or methods illustrated in FIG. 1 to FIG. 10 using any suitably configured hardware and/or software. In some embodiments, the computing device 1100 can include a processor 1112 that is communicatively coupled to a memory 1114 and that executes computer-executable program code and/or accesses information stored in the memory 1114. The processor 1112 may include a microprocessor, an application-specific integrated circuit (“ASIC”), a state machine, or other processing device. The processor 1112 can include any of a number of processing devices, including one. Such a processor can include or may be in communication with a computer-readable medium storing instructions that, when executed by the processor 1112, cause the processor to perform the operations described herein.

The memory 1114 can include any suitable non-transitory computer-readable medium. The computer-readable medium can include any electronic, optical, magnetic, or other storage device capable of providing a processor with computer-readable instructions or other program code. Non-limiting examples of a computer-readable medium include a magnetic disk, a memory chip, a read-only memory (ROM), a random access memory (RAM), an application specific integrated circuit (ASIC), a configured processor, optical storage, magnetic tape or other magnetic storage, or any other medium from which a computer processor can read instructions. The instructions may include processor-specific instructions generated by a compiler and/or an interpreter from code written in any suitable computer-programming language, including, for example, C, C++, C#, visual basic, java, python, perl, javascript, and actionscript.

The computing device 1100 can also include a bus 1116. The bus 1116 can communicatively couple one or more components of the computing device 1100. The computing device 1100 can also include a number of external or internal devices such as input or output devices. For example, the computing device 1100 is illustrated with an input/output (“I/O”) interface 1118 that can receive input from one or more input devices 1120 or provide output to one or more output devices 1122. The one or more input devices 1120 and one or more output devices 1122 can be communicatively coupled to the I/O interface 1118. The communicative coupling can be implemented via any suitable manner (e.g., a connection via a printed circuit board, connection via a cable, communication via wireless transmissions, etc.). Non-limiting examples of input devices 1120 include a touch screen (e g., one or more cameras for imaging a touch area or pressure sensors for detecting pressure changes caused by a touch), a mouse, a keyboard, or any other device that can be used to generate input events in response to physical actions by a user of a computing device. Non-limiting examples of output devices 1122 include a liquid crystal display (LCD) screen, an external monitor, a speaker, or any other device that can be used to display or otherwise present outputs generated by a computing device.

The computing device 1100 can execute program code that configures the processor 1112 to perform one or more of the operations described above with respect to some embodiments illustrated in FIG. 1 to FIG. 10. The program code may be resident in the memory 1114 or any suitable computer-readable medium and may be executed by the processor 1112 or any other suitable processor.

The computing device 1100 can also include at least one network interface device 1124. The network interface device 1124 can include any device or group of devices suitable for establishing a wired or wireless data connection to one or more data networks 1128. Non limiting examples of the network interface device 1124 include an Ethernet network adapter, a modem, and/or the like. The computing device 1100 can transmit messages as electronic or optical signals via the network interface device 1124.

FIG. 12 is a block diagram of an example of a communication system 1200 according to an embodiment of the present disclosure. Embodiments described herein may be implemented into the communication system 1200 using any suitably configured hardware and/or software. FIG. 12 illustrates the communication system 1200 including a radio frequency (RF) circuitry 1210, a baseband circuitry 1220, an application circuitry 1230, a memory/storage 1240, a display 1250, a camera 1260, a sensor 1270, and an input/output (I/O) interface 1280, coupled with each other at least as illustrated.

The application circuitry 1230 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system. The communication system 1200 can execute program code that configures the application circuitry 1230 to perform one or more of the operations described above with respect to FIG. 1 to FIG. 10. The program code may be resident in the application circuitry 1230 or any suitable computer-readable medium and may be executed by the application circuitry 1230 or any other suitable processor.

The baseband circuitry 1220 may include circuitry such as, but not limited to, one or more single-core or multi-core processors. The processors may include a baseband processor. The baseband circuitry may handle various radio control functions that may enable communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 1220 may include circuitry to operate with signals that are not strictly considered as being in a baseband frequency. For example, in some embodiments, baseband circuitry may include circuitry to operate with signals having an intermediate frequency, which is between a baseband frequency and a radio frequency. The RF circuitry 1210 may enable communication with wireless networks using modulated electromagnetic radiation through a non-solid medium. In various embodiments, the RF circuitry may include switches, filters, amplifiers, etc. to facilitate the communication with the wireless network. In various embodiments, the RF circuitry 1210 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to apparatuses and/or methods illustrated in FIG. 1 to FIG. 10 may be embodied in whole or in part in one or more of the RF circuitry, the baseband circuitry, and/or the application circuitry. As used herein, “circuitry” may refer to, be part of, or include an application specific integrated circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules. In some embodiments, some or all of the constituent components of the baseband circuitry, the application circuitry, and/or the memory/storage may be implemented together on a system on a chip (SOC). The memory/storage 1240 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 1280 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface. In various embodiments, the sensor 1270 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the display 1250 may include a display, such as a liquid crystal display and a touch screen display. In various embodiments, the communication system 1200 may be a mobile computing device such as, but not limited to, a laptop computing device, a tablet computing device, a netbook, an Ultrabook, a smartphone, an AR/VR glasses, etc. In various embodiments, system may have more or less components, and/or different architectures. Where appropriate, methods described herein may be implemented as a computer program. The computer program may be stored on a storage medium, such as a non-transitory storage medium.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan. A person having ordinary skill in the art can use different ways to realize the function for each specific application while such realizations should not go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized in other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

1. A wireless communication method for data transfer, comprising:
receiving, by a function entity, a first request, wherein the first request indicates quality-of-service (QoS) parameters associated with a list of time windows for Application Artificial Intelligence (AI)/Machine Learning (ML) Data Transfer (AAMDT); and
selecting, by the function entity, an AAMDT policy based on the QoS parameters.

2. The method according to claim 1, wherein the function entity is a Policy Control Function (PCF) entity.

3. The method according to claim 1, wherein the first request is an AAMDT policy control request, and the first request is request from an Application Function (AF) via a Network Exposure Function (NEF) entity.

4. The method according to claim 1, further comprising:
requesting, by the function entity, network performance analytics associated with the QoS parameters.

5. The method according to claim 4, wherein the AAMDT policy is selected based on the network performance analytics.

6. The method according to claim 1, further comprising:
sending, by the function entity, the AAMDT transfer policy.

7. The method according to claim 6, wherein the AAMDT transfer policy is sent to the AF.

8. The method according to claim 1, further comprising:
receiving, by the function entity, a second request to create or update the AAMDT policy.

9. The method according to claim 8, wherein the second request is an AF request, and the AAMDT policy is associated with the AAMDT for a protocol data unit (PDU) session served by the function entity.

10. (canceled)

11. The method according to claim 8, further comprising:
retrieving, by the function entity, an AAMDT policy from a User Data Repository (UDR) entity.

12. The method according to claim 11, further comprising:
deriving, by the function entity, a set of policy and charging control (PCC) rules for the AAMDT based on the AAMDT policy.

13. (canceled)

14. The method according to claim 1, wherein the QoS parameters comprises a guaranteed bit rate (GBR) and at least one of a packet delay budget (PDB), a packet loss rate (PLR), and a traffic rate.

15-56. (canceled)

57. A network device, comprising:
a memory;
a transceiver; and
a processor coupled to the memory and the transceiver;
wherein the network device is configured to: receive a first request, wherein the first request indicates quality-of-service (QoS) parameters associated with a list of time windows for Application Artificial Intelligence (AI)/Machine Learning (MHL) Data Transfer (AAMDT); and
select an AAMDT policy based on the QoS parameters.

58-62. (canceled)

63. The network device according to claim 57, wherein the network device is a Policy Control Function (PCF) entity.

64. The network device according to claim 57, wherein the first request is an AAMDT policy control request, and the first request is request from an Application Function (AF) via a Network Exposure Function (NEF) entity.

65. The network device according to claim 57, wherein the network device is further configured to request network performance analytics associated with the QoS parameters.

66. The network device according to claim 65, wherein the AAMDT policy is selected based on the network performance analytics.

67. The network device according to claim 57, wherein the network device is further configured to receive a second request to create or update the AAMDT policy.

68. The network device according to claim 67, wherein the second request is an AF request, and the AAMDT policy is associated with the AAMDT for a protocol data unit (PDU) session served by the wireless communication device.

69. A chip, comprising:
a processor, configured to call and run a computer program stored in a memory, to cause a device in which the chip is installed to:
receive a first request, wherein the first request indicates quality-of-service (QoS) parameters associated with a list of time windows for Application Artificial Intelligence (AI)/Machine Learning (ML) Data Transfer (AAMDT); and
select an AAMDT policy based on the QoS parameters.
